(19) United States
(12) Patent Application Publication
(10) Pub. No.: US 2011/0020569 A1
(43) Pub. Date: Jan. 27, 2011

(54) PROCESS FOR CONNECTING A TUBE STABILIZER PART OF A DIVIDED TUBE STABILIZER HAVING AN INTERMEDIATE ELEMENT, AND A TUBE STABILIZER

(75) Inventors: Ullrich HAMMELMAIER, Paderborn (DE); Anreas Janzen, Peckelsheim (DE); Sebastian Saggel, Paderborn (DE); Markus Kleine, Erwitte (DE)

Correspondence Address: BARNES & THORNBURG LLP, 750-17TH STREET NW, SUITE 900, WASHINGTON, DC, 20006-4675, US

(73) Assignee: BENTELER AUTOMOBILE TECHNIK GMBH, Paderborn (DE)

(21) Appl. No.: 12/841,709

(22) Filed: Jul. 22, 2010

(30) Foreign Application Priority Data
Jul. 24, 2009 (DE) 10 2009 026 246.6

(51) Int. Cl. B32B 1/08; B23K 31/02; B23P 11/00; B21D 19/00

(52) U.S. Cl. 428/34.1; 228/173.4; 29/428; 72/370.11

(57) ABSTRACT

A process for connecting a tube stabilizer part of a divided tube stabilizer with an intermediate element, such as an actuator or shift transmission. The process steps include providing the tube stabilizer part, providing the intermediate element, widening an end-side section of the tube stabilizer part using a conical mandrel, and bending the tube stabilizer part, and connecting the tube stabilizer part with the intermediate element.

### BACKGROUND OF THE INVENTION

This is an application claiming priority to and benefit of German Patent Application Number 10 2009 026 246.6 filed Jul. 24, 2009 in Germany, the subject matter of which is incorporated by reference herein.

### BACKGROUND SUMMARY

The present disclosure relates to a process for connecting a tube stabilizer part of a divided tube stabilizer with an intermediate element, and to a corresponding tube stabilizer.

Tube stabilizers are used in the case of motor vehicles as a torsion bar between the two wheels of an axle. They have the purpose of limiting the roll of the vehicle during the reciprocal compression of the wheels of an axle. When a tube stabilizer is active, an actuator is used between two torsion bars, which actuator can actively influence the roll of the vehicle. When, in the case of major torsional stress, the angular deflection of a one-piece stabilizer is not sufficient, a shiftable clutch is placed between the two stabilizer parts.

In the prior art, the connection of the actuator or of the shift transmission with the stabilizer parts is implemented by friction welding, form connections or with the aid of adapters. However, such solutions with adapters or by form closure lead to high expenditures when carrying out the process.

The present disclosure provides for a process, or method, for connecting a tube stabilizer part to an intermediate element in a direct manner without any adapter, which process, or method, can be reliably controlled and ensures the reproducibility required for a series production.

The process includes connecting a tube stabilizer part of a divided tube stabilizer with an intermediate element such as, for example, an actuator or a shift transmission. The present disclosure also provides for a tube stabilizer having two stabilizer parts between which an intermediate element is arranged.

According to the process of the present disclosure, an interior-side section and an end-side section of the tube stabilizer part are widened by a conical mandrel. Before or after the widening of the end-side section, the tube stabilizer part is bent into its final shape. The widened and bent tube stabilizer part is then material-lockingly connected with the intermediate element. By the conical construction of the mandrel, a detachment of the interior surface of the tube stabilizer part is prevented and a defined interior surface of the tube stabilizer part is thereby produced. The mandrel geometry also results in low deforming forces. Furthermore, by the mandrel geometry, a superimposition of the vertical and radial flow of the tube stabilizer material will also be avoided.

For a stable connection, before the welding-together of the parts, the end-side section of the tube stabilizer part can, after the widening, be mechanically processed, faced or milled, and be provided with a preparatory welding treatment. By such a mechanical joint preparation, the tube stabilizer part can be welded well. In order to obtain a precise exterior surface of the widened section of the tube stabilizer part, in an embodiment according to the present disclosure, the widening of the end-section section of the tube stabilizer part takes place with the aid of a die.

In order to avoid a heat flux into the intermediate element during the welding operation, a cooling of the tube stabilizer part and/or of the intermediate element is carried out during the welding-together.

For the widening of the interior-side section and/or the end-side section of the tube stabilizer part, a separate tool, shaped as a conical mandrel, or a part, which is shaped as a conical mandrel, of the connection element constructed as a flange, can be used. An advantage of the use of the part of the flange shaped as a conical mandrel includes the creation of an additional force fit as well as an advantageous weld seam preparation because, as a result of the flange itself, no air gap is created between the parts.

Within the scope of the present disclosure, a combined use is possible of the separate tool and of the part of the flange shaped as a conical mandrel for widening the interior-side section and/or the end-side section of the tube stabilizer part, for example, by a prewidening to be carried out by the tool and a subsequent final widening by using a connection element constructed as a flange.

The tube stabilizer, according to the present disclosure, may have two tube stabilizer parts, between which an intermediate element is arranged. At least one of the tube stabilizer parts, on the end side, has a radial outward-projecting, conically widened section which is connected with the intermediate element at least partially in a material-locking manner. The linking of the tube stabilizer part to the intermediate element is thus distinguished by a manufacturing process that is advantageously reliable and controllable.

The tube material of the tube stabilizer parts advantageously hardens in air and therefore exhibits no decrease in hardness in the weld seam.

For a secure gluing of the tube stabilizer part to the intermediate element, the intermediate element is provided with a connection piece which is equipped on the circumference with a groove for feeding an adhesive.

For further improving a welded connection between the two parts, the connection piece can be provided with a preparatory treatment of the weld seam on its circumference.

In an alternative embodiment, the connection piece can be constructed as a flange which is screwed, welded or attached to the intermediate element. By a flange, a standardized connection element can be created so that a mechanical machining of the widened end of the tube stabilizer part can largely be eliminated.

Other aspects f the present disclosure will become apparent from the following descriptions when considered in conjunction with the accompanying drawings.

### BRIEF DESCRIPTION OF THE DRAWINGS

FIG. 1 is a schematic perspective view of the widening operation of a tube stabilizer part, according to the present disclosure.

FIG. 2 is a schematic sectional view of another embodiment of a tube stabilizer having an intermediate element welded to the tube stabilizer parts, according to the present disclosure.

FIG. 3 is a schematic perspective view of another embodiment, according to the present disclosure, showing a tube stabilizer part coupled to a connection element via an intermediate element.

FIG. 4 is a schematic side view of the embodiment of FIG. 3.

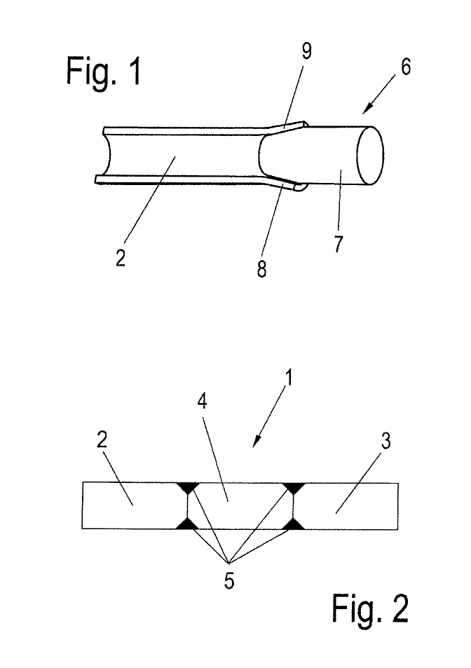

### DETAILED DESCRIPTION

A divided tube stabilizer 1 includes two tube stabilizer parts 2, 3 and an intermediate element 4 arranged between the two tube stabilizer parts 2, 3. The intermediate element 4 can be constructed, for example, as part of an active stabilizer as an actuator or, in the case of a shiftable stabilizer, as a shift transmission. In an embodiment according to the present disclosure, a circular-ring-shaped cross-section of the tube stabilizer parts 2, 3 may have a constant construction over their entire length or a cross-section which changes in sections, for example, for forming stable sections of the tube stabilizer parts 2, 3 or for saving material on less stressed sections of the tube stabilizer parts 2,3. The changing of the cross-section of a tube stabilizer part 2, 3 may include an enlargement or a reduction of the inside or outside diameters of the tube stabilizer part 2, 3.

As illustrated in FIG. 1, the tube stabilizer parts 2, 3 have widened sections 9 at their ends facing the intermediate element 4, which widened sections 9 are connected by way of weld seams 5 with the intermediate element 4.

For widening the end-side sections 9 of the tube stabilizer parts 2, 3, a conical mandrel 6 is driven into the end-side section 9. The mandrel 6 may also partially have a cylindrical construction, in which case a cylindrical section 7 adjoins a conical section 8. It is important that only the conical portion 8 of the mandrel 6 is driven into the end-side section 9 of the tube stabilizer part 2, 3 in order to prevent a detachment of the interior surface of the end-side section 9 and thus produce a defined interior surface of the end-side section 9. In this case, the widening of the end-side section 9 can be carried out in the cold or warm condition of the tube stabilizer part 2, 3.

Following the widening of the end-side section 9, the tube stabilizer part 2, 3 is bent into its final shape. The bending of the tube stabilizer part 2, 3 into its final shape optionally can also be carried out before the widening of the end-side section 9. Subsequently, the material-locking connection of the tube stabilizer part 2, 3 with the intermediate element 4 takes place. It is within the scope of the present disclosure that connecting methods may include welding processes such as MIG, MAG, laser welding, plasma welding, high-impulse welding, CNT, or also gluing.

For the material-locking connection by welding, after the widening, the end-side section 9 of the tube stabilizer part 2, 3 can first be mechanically treated. In this mechanical treatment, the end-side section 9 is, for example, faced or milled, and provided with a preparatory welding treatment, for example, in the form of a bevel.

Furthermore, after the bending or widening, the tube stabilizer part 2, 3 is subjected to a heat treatment, unless this has taken place earlier.

In an embodiment of the process according to the present disclosure, the widening of the end-side section 9 of the tube stabilizer part 2, 3 may take place with the aid of a die in order to assist the forming operation within predetermined tolerance limits.

In order to avoid a heat flux into the intermediate element 4, it is within the scope of the present disclosure for the process to cool the intermediate element 4 and/or the tube stabilizer part 2, 3, or a clamping-chuck clamping of these parts during the welding operation. This cooling can take place by a fluid cooling or air cooling. Furthermore, a one-side or a two-side cooling of the parts is within the scope of the present disclosure. The welding operation can take place by one or two welding guns, and the weld seam can be implemented as a single weld seam as well as a double weld seam.

For relieving the weld seams 5, a weld seam relief may be molded to the exterior shell side of the intermediate element 4. This seam relief may take place by geometric adaptation of the exterior shell side of the intermediate element 4, for example, by a molding-on step.

In a further embodiment according to the present disclosure, the intermediate element 4 is provided with a connection piece which, in the condition connected with the tube stabilizer part 2, 3, projects in a centering manner into the conically widened section 9 of the tube stabilizer part 2, 3. If the two parts are to be welded together, the connection piece is provided on the circumference also with a preparatory weld seam treatment. In the case of a material-locking connection of the two parts by gluing, the connection piece has a groove for the feeding of an adhesive on the circumference.

According to another embodiment of the present disclosure, the connection piece is dimensioned such that the connection between the connection piece and the tube stabilizer part 2 is constructed as a force fit and thus offers an additional support to the connection of the two parts. In this case, the diameter of the connection piece may be greater or smaller than the diameter of the tube stabilizer part 2, 3, and thus the connection part may reach over the tube stabilizer part 2, 3 or the other way around.

In the case of the above-mentioned material-locking connection of the intermediate piece 4 to the tube stabilizer part 2, 3, same-size diameters of the intermediate piece 4 and of the tube stabilizer piece 2, 3 are within the scope of the present disclosure.

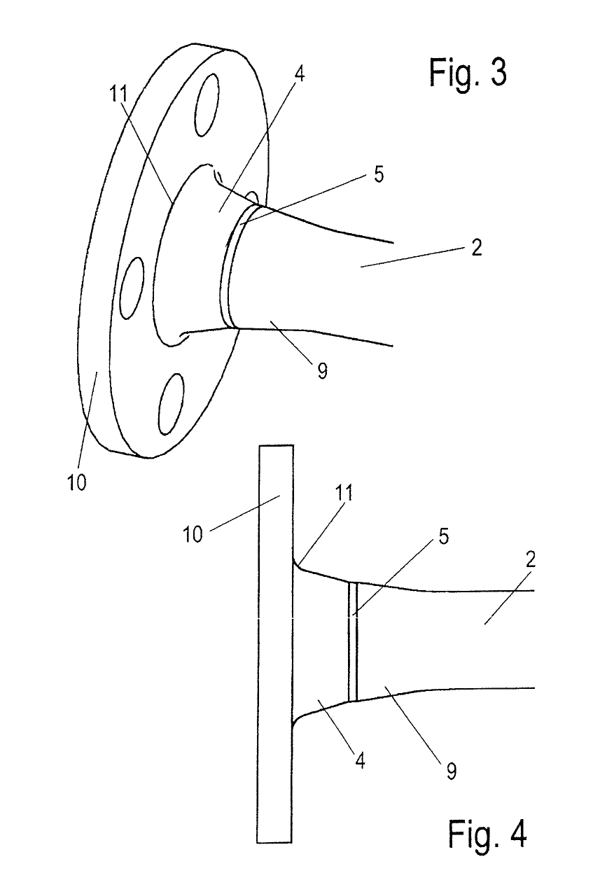

In another embodiment according to the present disclosure, the intermediate element 4 is connected by, for example, a weld seam 11, with a connection element 10 for the linking of the tube stabilizer 1 to other vehicle parts, as shown and suggested in FIGS. 3 and 4. The connection element 10 may be constructed as a flange. The flange may be screwed, welded or attached to the connection element 4. By such a connection element 10, a standardized connection element is created which separately can be preprocessed to such an extent that a mechanical treatment of the end-side section 9 of the tube stabilizer part 2, 3 can be largely or even completely avoided.

For the widening of the interior-side section of the tube stabilizer part 2, the mandrel 6, according to an embodiment of the present disclosure, is constructed as a separate tool. In another embodiment according to the present disclosure, the conical mandrel 6 is constructed as part of the connection element 10 which may be constructed as a flange. This creates an additional force fit between the connection element 10 and, for example, the tube stabilizer part 2. In addition, an ideal weld seam preparation may also created because, as a result of the use of the flange as the widening tool, no air gap is formed between the parts.

Within the scope of the present disclosure, a combined use is possible of the separate tool and of the part of the flange shaped as a conical mandrel 6 for widening the interior-side section and/or the end-side section of the tube stabilizer part 2,3. For example, this can be done by a prewidening to be carried out by the tool and a subsequent final widening by using the connection element, which may be constructed as a flange.

Finally, after heat treatment of either of the tube stabilizer parts 2, 3 or both tube stabilizer parts 2, 3 or, after the material-locking connecting of the tube stabilizer parts 2, 3 to the intermediate element 4, an anticorrosive agent may at least partially be applied to the tube stabilizer 1.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A process for connecting a tube stabilizer part of a divided tube stabilizer with an intermediate element, such as an actuator or shift transmission, the process steps comprising:
providing the tube stabilizer part;
providing the intermediate element;
widening an end-side section of the tube stabilizer part using a conical mandrel;
bending the tube stabilizer part; and
material-lockingly connecting the tube stabilizer part with the intermediate element.

2. The process according to claim 1, wherein the end-side section is mechanically processed after the widening.

3. The process according to claim 2, wherein the end-side section of the tube stabilizer part is faced or milled.

4. The process according to claim 2, wherein the end-side section is provided with a preparatory weld treatment.

5. The process according to claim 1, wherein the tube stabilizer part is first bent and subsequently widened.

6. The process according to claim 1, wherein after the bending or the widening, the tube stabilizer part is subjected to a heat treatment.

7. The process according to claim 1, wherein the widening of the end-side section of the tube stabilizer part takes place with the aid of a die.

8. The process according to claim 6, wherein after the heat treatment of the tube stabilizer part or after the material-locking connecting of the tube stabilizer part to the intermediate element, an anti-corrosion agent is at least partially applied to the tube stabilizer.

9. The process according to claim 1, wherein the material-locking connecting is done by welding and, when welding together the tube stabilizer part and the intermediate element, a cooling of one or both of the tube stabilizer part and the intermediate element is carried out.

10. The process according to claim 1, wherein the widening of the end-side section of the tube stabilizer part takes place by part of a connection element for linking the tube stabilizer to other vehicle parts, which part is shaped as a conical mandrel.

11. The process according to claim 1, wherein the widening of the end-side section of the tube stabilizer part is partially carried out by a tool shaped as a conical mandrel and partially by a part of a connection element for linking the tube stabilizer to other vehicle parts, which part is shaped as a conical mandrel.

12. A tube stabilizer comprising:
two stabilizer parts;
an intermediate element arranged between the two stabilizer parts; and
at least one of the two stabilizer parts has a radial outward-projecting conically-widened section on an end side, which conically widened section is at least partially connected in a material-locking manner with the intermediate element.

13. The tube stabilizer according to claim 12, wherein a tube material of the tube stabilizer parts hardens in air.

14. The tube stabilizer according to claim 12, wherein a cross-section of at least one of the tube stabilizer parts has a different construction in sections.

15. The tube stabilizer according to claim 12, wherein a seam relief is molded to an exterior shell side of the intermediate element.

16. The tube stabilizer according to claim 15, wherein the seam relief is constructed as a step.

17. The tube stabilizer according to claim 12, wherein the intermediate element includes at least one connection piece which, in a condition connected with the tube stabilizer part, projects in a centering manner into the conically widened section of the tube stabilizer part.

18. The tube stabilizer according to claim 17, wherein, on its circumference, the connection piece is provided with a groove for feeding an adhesive.

19. The tube stabilizer according to claim 17, wherein, on its circumference, the connection piece is provided with a preparatory weld seam treatment.

20. The tube stabilizer according to claim 17, wherein the connection between the connection piece and the tube stabilizer part is constructed as a force fit.

21. The tube stabilizer according to claim 17, wherein a connection element is provided linking the tube stabilizer to vehicle parts and is mounted on the connection piece.

22. The tube stabilizer according to claim 21, wherein the connection element is constructed as a flange.

23. The tube stabilizer according to claim 22, wherein the flange is screwed or welded to the intermediate element or is attached to the intermediate element.

24. The tube stabilizer according to claim 21, wherein a conical mandrel is molded onto the connection element.
